(19) United States
(12) Patent Application Publication
(10) Pub. No.: US 2023/0000168 A1
(43) Pub. Date: Jan. 5, 2023

(54) AEROSOL PROVISION SYSTEMS

(71) Applicant: Nicoventures Trading Limited, London (GB)

(72) Inventor: Patrick MOLONEY, London (GB)

(21) Appl. No.: 17/756,485

(22) PCT Filed: Nov. 27, 2020
(86) PCT No.: PCT/EP2020/083802

§ 371 Date: May 26, 2022

(30) Foreign Application Priority Data
Nov. 29, 2019 (GB) 1917489.5

(51) Int. Cl. A24F 40/57; A24F 40/42; A24F 40/20; A24F 40/51; A24F 40/30; A24F 40/53; A24F 40/46; H05B 1/02

(52) U.S. Cl. CPC A24F 40/57; A24F 40/42; A24F 40/20; A24F 40/51; A24F 40/30; A24F 40/53; A24F 40/46; H05B 1/0227; H05B 2203/005

(57) ABSTRACT

An aerosol provision system for generating aerosol for user inhalation is disclosed. The aerosol provision system comprises a replaceable part comprising a substrate providing aerosol generating material for generating the aerosol for user inhalation and a reusable part comprising: a housing including an interface configured to operatively engage with the replaceable part, and an air channel configured at least partially in the housing to provide a passage of air drawn by user inhalation to receive the aerosol generated from the aerosol generating material, a detector configured to detect the passage of air drawn through the air channel; at least one aerosol generating element disposed with respect to the interface and configured, in use, to generate aerosol from the aerosol generating material, and a control circuit configured to receive a signal from the detector indicating an amount of air drawn by the user and to control the at least one aerosol generating element to generate the aerosol selectively from different regions of the aerosol generating material in response to the amount of air drawn through the air channel.

### PRIORITY CLAIM

The present application is a National Phase entry of PCT Application No. PCT/EP2020/083802, filed Nov. 27, 2020, which claims priority from Great Britain Application No. 1917489.5, filed Nov. 29, 2019, each of which is hereby fully incorporated herein by reference.

### TECHNICAL FIELD

The present technique relates to aerosol provision systems, methods of generating an aerosol in aerosol provision devices (e.g. electronic cigarettes and the like), and a replaceable/consumable for use in an aerosol provision device.

### BACKGROUND

Aerosol provision devices are known. Common devices use heaters to create an aerosol from a suitable medium which is then inhaled by a user. Often suitable media require significant levels of heating prior to generating an aerosol for inhalation. Similarly, current devices offer users a large variety in the media from which inhalable aerosol can be generated. Current devices often require a change in the device, such as the loading of the media, to enable a change in the aerosol generating medium active within the device. Accordingly, it is conventional for such devices to include a replaceable part which can provide a source of energy and a heating element and a consumable or replaceable part which contains an aerosol generating medium which when exhausted is replaced.

It is desirable for aerosol provision devices to rapidly deliver an aerosolized payload to a user. Therefore there is a requirement to avoid long warm up times prior to a user receiving an aerosolized payload.

The present disclosure is directed toward solving some of the above problems.

Various approaches are described herein which seek to help address or mitigate at least some of the issues discussed above.

### SUMMARY

According to a first aspect of certain embodiments there is provided an aerosol provision system for generating aerosol for user inhalation, the aerosol provision system comprising a replaceable part and a reusable part. The replaceable part comprises a substrate comprising aerosol generating material for generating the aerosol for user inhalation. In some examples the housing of the replaceable part may include an air channel and the substrate may be disposed with respect to the air channel so that air passing through the air channel drawn by user inhalation carries the aerosol generated by the substrate to the user. In other examples the replaceable part may not include an air channel itself but is instead configured to be disposed in an air channel provided by the reusable part. The reusable part comprises a housing including an interface configured to operatively engage with the replaceable part, and an air channel configured at least partially in the housing to provide a passage of air drawn by the user to receive the aerosol generated from the aerosol generating material. A detector is configured to detect a passage of air drawn through the air channel, and at least one aerosol generating element or cell is disposed with respect to the interface and configured, in use, to generate the aerosol from the aerosol generating material. A control circuit is configured to receive a signal from the detector indicating an amount of air drawn by the user and to control the at least one aerosol generating element to generate the aerosol selectively from different regions of the aerosol generating material in response to the amount of air drawn through the air channel. According to this example, the at least one aerosol generating element is configured with respect to the substrate of the replaceable part to generate aerosol selectively from different regions of the aerosol generating material in accordance with the amount of air drawn by the user to generate a selectable amount of the aerosol.

In some example embodiments the substrate is configured to be moved with respect to the at least one aerosol generating element so that the aerosol can be generated from the different regions of the aerosol generating material. In other examples the at least one aerosol generating element comprises a plurality of aerosol generating elements which may be selectively activated in series (sequentially) or in parallel to generate the aerosol at different rates or for different durations.

In some examples the different regions of the aerosol generating material may be discrete portions or dots, but in other examples aerosol generating material may be a continuous deposit, sheet or medium and the different regions are different sections of a continuous or contiguous deposit of the aerosol generating material on the substrate.

According to the example embodiments, the control circuit controls the at least one aerosol generating element to generate aerosol from different regions of the aerosol generating material in proportion to one or both of a strength of a user's puff (an amount of air drawn per unit time) and a duration of the user's puff (air draw duration).

It will be appreciated that features and aspects of the disclosure described herein in relation to the first and other aspects of the disclosure are equally applicable to, and may be combined with, embodiments of the disclosure according to other aspects of the disclosure as appropriate, and not just in the specific combinations described above.

### BRIEF DESCRIPTION OF THE DRAWINGS

Embodiments of the disclosure will now be described, by way of example only, with reference to the accompanying drawings, in which:

FIG. 1 is a schematic sectional view of a portion of an aerosol provision device (e-cigarette) which includes a reusable part and a consumable part according to an example embodiment;

FIG. 2 is a three-dimensional representation of the different components of the aerosol provision device (e-cigarette) comprising the reusable part, and the consumable part of FIG. 1;

FIG. 3 is an expanded view of a representation in layers of components of an aerosol provision device according to an example embodiment of the present technique;

FIG. 4 is a schematic block diagram of components of the aerosol provision device providing an example cell of an embodiment of the present technique;

FIG. 5 is an illustrative arrangement of a plurality of gel portions of an aerosol generating material disposed with respect to a corresponding plurality of heating elements;

FIG. 6 is a schematic representation of an aerosol provision device according to another example embodiment;

FIG. 7 is example of a disk shaped substrate on which a continuous portion of aerosol generating gel is disposed;

FIG. 8 is a schematic block diagram of components of the aerosol provision device providing an example cell of an example embodiment of the present technique corresponding to FIG. 4;

FIG. 9 is a schematic representation of an aerosol provision device according to another example embodiment corresponding to FIG. 5; and

FIG. 10 is a graphical plot of temperature in the vicinity of the heater or heaters with respect to time illustrating an operation of the examples shown in FIGS. 8 and 9.

### DETAILED DESCRIPTION OF THE DRAWINGS

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to aerosol provision systems, which may also be referred to as heat not burn systems, such as e-cigarettes. Throughout the following description the term “e-cigarette” or “electronic cigarette” may sometimes be used, but it will be appreciated this term may be used interchangeably with aerosol provision system/device and electronic aerosol provision system/device. Furthermore, and as is common in the technical field, the terms “vapor” and “aerosol”, and related terms such as “vaporize”, “volatilize” and “aerosolize”, may generally be used interchangeably.

Aerosol provision systems (e-cigarettes) often, though not always, comprise a modular assembly including both a reusable part (control unit part) and a replaceable (disposable) cartridge part. Often the replaceable cartridge part will comprise the vapor precursor material and the vaporizer and the reusable part will comprise the power supply (e.g. rechargeable battery) and control circuit. It will be appreciated these different parts may comprise further elements depending on functionality. For example, the reusable device part may comprise a user interface for receiving user input and displaying operating status characteristics, and the replaceable cartridge part may comprise a temperature sensor for helping to control temperature. Cartridges are electrically and mechanically coupled to a control unit for use, for example using a screw thread, latching or bayonet fixing with appropriately engaging electrical contacts. When the vapor precursor material in a cartridge is exhausted, or the user wishes to switch to a different cartridge having a different vapor precursor material, a cartridge may be removed from the control unit and a replacement cartridge attached in its place. Devices conforming to this type of two-part modular configuration may generally be referred to as two-part devices. It is also common for electronic cigarettes to have a generally elongate shape. For the sake of providing a concrete example, certain embodiments of the disclosure described herein will be taken to comprise this kind of generally elongate two-part device employing disposable cartridges. However, it will be appreciated the underlying principles described herein may equally be adopted for different electronic cigarette configurations, for example single-part devices or modular devices comprising more than two parts, refillable devices and single-use disposable devices, as well as devices conforming to other overall shapes, for example based on so-called box-mod high performance devices that typically have a more box-like shape. More generally, it will be appreciated certain embodiments of the disclosure are based on approaches for seeking to help more reliably form a seal for an opening in a reservoir wall through which a wick passes in accordance with the principles described herein, and other constructional and functional aspects of electronic cigarettes implementing approaches in accordance with certain embodiments of the disclosure are not of primary significance and may, for example, be implemented in accordance with any established approaches.

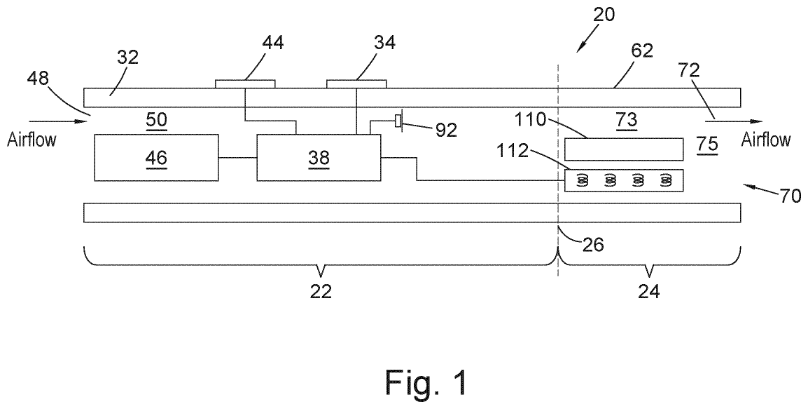

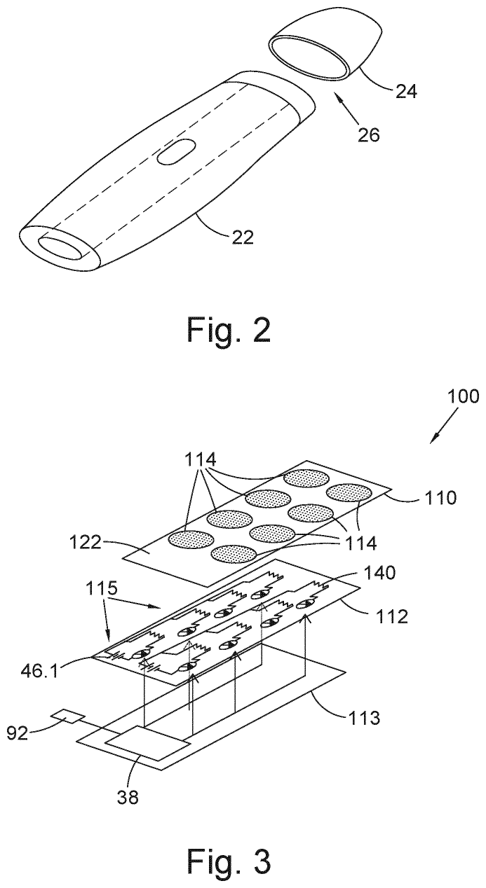

FIG. 1 is a cross-sectional view through an example aerosol provision device 20 in accordance with certain embodiments of the disclosure, with a corresponding three dimensional representation shown in FIG. 2. As shown in FIGS. 1 and 2, the aerosol provision device 20 comprises two main components, namely a reusable part 22 and a replaceable part 24 also referred to as a consumable. In normal use the reusable part 22 and the replaceable/cartridge part 24 are releasably coupled together at an interface 26. When the replaceable/cartridge part 24 is exhausted or the user simply wishes to switch to a different cartridge part, the cartridge part may be removed from the reusable part and a replacement cartridge part attached to the reusable part in its place. The interface 26 provides a structural, electrical and air path connection between the two parts and may be established in accordance with conventional techniques, for example based around a screw thread, latch mechanism, push-fit or friction fit, or bayonet fixing with appropriately arranged electrical contacts and openings for establishing the electrical connection and air path between the two parts as appropriate. The specific manner in which the replaceable part 24 mechanically couples to the reusable part 22 is not significant to the principles described herein, but for the sake of a concrete example is assumed here to comprise a latching mechanism, for example with a portion of the cartridge being received in a corresponding receptacle in the reusable part with cooperating latch engaging elements (not represented in FIG. 2). It will also be appreciated the interface 26 in some implementations may not support an electrical and/or air path connection between the respective parts. For example, in some implementations a vaporizer may be provided in the reusable part rather than in the cartridge part, or the transfer of electrical power from the reusable part to the cartridge part may be wireless (e.g. based on electromagnetic induction), so that an electrical connection between the reusable part and the cartridge part is not needed. Furthermore, in some implementations the airflow through the electronic cigarette might not go through the reusable part so that an air path connection between the reusable part and the cartridge part is not needed.

The replaceable part 24 may in accordance with certain embodiments of the disclosure be broadly conventional apart from where modified in accordance with the approaches described herein in accordance with certain embodiments of the disclosure. In FIG. 1, the replaceable part 24 comprises a housing 62 formed of a plastics material. In other examples the housing 62 may be at least partly formed from paper and/or card. For example, the housing 62 may be paper wrapped around one or more (cylindrical) portions of aerosol generating material. The replaceable housing 62 may support other components of the replaceable part 24 and provides the mechanical interface 26 with the reusable part 22. The replaceable housing is generally circularly symmetric about a longitudinal axis along which the replaceable part couples to the reusable part 22. In this example the replaceable part has a length of around 4 cm and a diameter of around 1.5 cm. However, it will be appreciated the specific geometry, and more generally the overall shape and materials used, may be different in different implementations.

Broadly speaking, however, in accordance with the principles of the present disclosure, the replaceable part 24 comprises or consists of one or more portions of aerosol generating material. The replaceable part 24 is the component which provides the aerosol generating material to the reusable part 22 and, when engaged with the reusable part 22, is able to be used to generate aerosol for user inhalation.

In some examples, the replaceable part 24 consists of, and is formed entirely of, the aerosol generating material. In these examples, the substrate 110 as used herein may refer to either the replaceable part 24 or the aerosol generating material. That is, the replaceable part, aerosol generating material and substrate may be one and the same. In these examples, the reusable part 22 may be configured to receive the aerosol generating material, e.g., via a suitable receptacle acting as the interface 26.

In other examples, the reusable part 22 may comprise a support on which the aerosol generating material may be deposited. In these implementations, the combination of the support and aerosol generating material may be referred to as the substrate 110. In these examples, the reusable part 22 may consist of, or comprise, the substrate 110. In one example, the substrate 110 may be housed in the replaceable part 24, e.g., in a plastic housing, and the plastic housing of the replaceable part 24 is configured to engage with the reusable part 22 at the interface 26. Alternatively, the replaceable part 24 may consist of the substrate 110 and the reusable part 22 may be configured to receive the substrate 110, e.g., via a suitable receptacle acting as the interface 26. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

For the purposes of a concrete disclosure, the replaceable part 24 comprises a replaceable housing 62 within which the substrate 110 is housed. However, it should be appreciated that certain aspects of the present disclosure may be equally applied regardless of the form of the replaceable part 24.

As shown in FIG. 1, within the replaceable housing 62 is a layer providing a substrate 110 on which is disposed aerosol generating material. The substrate is supported by one or more walls of the housing 62 in close proximity to a heating layer 112 which may protrude from the reusable part 22 into the replaceable part 24. As shown in FIG. 1, the replaceable part 24 in some examples includes an air channel 72, 75. The reusable part 22 comprises an outer housing 32 with an opening that defines an air inlet 48 for the e-cigarette, a battery 46 for providing operating power for the electronic cigarette, control circuitry 38 for controlling and monitoring the operation of the electronic cigarette, a user input button 34 and a visual display 44.

The outer housing 32 may be formed, for example, from a plastics or metallic material and in this example has a circular cross-section generally conforming to the shape and size of the replaceable part 24 so as to provide a smooth transition between the two parts at the interface 26. In this example, the reusable part has a length of around 8 cm so the overall length of the e-cigarette when the replaceable part and reusable part are coupled together is around 12 cm. However, and as already noted, it will be appreciated that the overall shape and scale of an electronic cigarette implementing an embodiment of the disclosure is not significant to the principles described herein.

The air inlet 48 connects to an air path 50 through the reusable part 22. The reusable part air path 50 in turn connects to the replaceable part air path 72 across the interface 26 when the reusable part 22 and replaceable part 24 are connected together. Thus, when a user inhales on the mouthpiece opening 70, air is drawn in through the air inlet 48, along the reusable part air path 50, across the interface 26, through the vapor generation region 73 in the vicinity of the aerosol generating material, along the replaceable part air path 72, through an air channel 75 and out through the mouthpiece opening 70 for user inhalation.

Therefore according to the example shown in FIG. 1, the replaceable part 24 includes an air channel 75. However, in other embodiments, the replaceable part 24 may not include an air channel. In these embodiments, the replaceable part 24 is configured with an arrangement of the substrate to the effect that when the replaceable part 24 is engaged with the reusable part 22, the substrate 110 is disposed with respect to the air channel 72 formed in the reusable part 22 so that air passing through an air channel 50, of the reusable 22 part drawn by user inhalation carries the aerosol generated by the substrate 110 of the replaceable part 24 to the user. For example, the substrate 110 may be disposed in the air channel 50, such that air may pass over one or more surfaces of the substrate 110.

A battery 46 in this example may be rechargeable and may be of a conventional type, for example of the kind normally used in electronic cigarettes and other applications requiring provision of relatively high currents over relatively short periods. The battery 46 may be recharged through a charging connector in the reusable part 22 housing 32, for example a USB connector (not shown).

The user input button 34 in this example is a conventional mechanical button, for example comprising a spring mounted component which may be pressed by a user to establish an electrical contact. In this regard, the input button may be considered an input device for detecting user input and the specific manner in which the button is implemented is not significant. For example, other forms of mechanical button(s) or touch-sensitive button(s) (e.g. based on capacitive or optical sensing techniques) may be used in other implementations.

The display 44 is provided to provide a user with a visual indication of various characteristics associated with the aerosol provision device, for example current power setting information, remaining battery power, and so forth. More generally, the manner in which the display is provided and information is displayed to a user using the display is not significant to the principles described herein. For example, some embodiments may not include a visual display and may include other means for providing a user with information relating to operating characteristics of the aerosol provision device, for example using audio signaling or haptic feedback, or may not include any means for providing a user with information relating to operating characteristics of the aerosol provision device.

Control circuitry 38 is suitably configured/programmed to control the operation of the electronic cigarette to provide functionality in accordance with the established techniques for operating electronic cigarettes. For example, the control circuitry 38 may be configured to control a supply of power from the battery 46 to a heat controller, which controls the heating layer 112 to generate vapor from a portion of one or more doses of the material in the replaceable part 24 for user inhalation via the mouthpiece outlet 70 in response to user activation of the input button 34, or in other implementations in response to other triggers, for example in response to detecting user inhalation. The control circuitry (processor circuitry) 38 may be considered to logically comprise various sub-units/circuitry elements associated with different aspects of the aerosol provision device's operation, for example user input detection, power supply control, display driving, and so on. It will be appreciated the functionality of the control circuitry 38 can be provided in various different ways, for example using one or more suitably programmed programmable computer(s) and/or one or more suitably configured application-specific integrated circuit(s)/circuitry/chip(s)/chipset(s) configured to provide the desired functionality.

As will be explained in more detail below, the control circuitry may also include a memory and a clock/timer in order to estimate an amount of gel which has been used during a puff and therefore an amount remaining. Accordingly the control circuitry can determine whether a gel portion has been exhausted.

The term puff as used herein refers to a continuous or effectively continuous draw of air through the air channel by a user to inhale vapor from the aerosol provision device.

The aerosol provision system in FIGS. 1 and 2 differs from conventional electronic cigarettes in a manner in which portion of the aerosol generating material are heated to generate an aerosol for user inhalation in response to an amount of air drawn by the user though the air channel 50, 72 through the mouth piece 70. As will be explained with reference to FIGS. 3, 4 and 5 the control circuit 38 controls the heater layer 112 selectively energize different heating elements of the heating layer 112 in response to an amount of air flow in the air channel 50, 72 as detected by an air flow detector 92. According to example embodiments of the present technique therefore the aerosolizable provision device is configured to provide a puff response, that is, an amount of heating and/or aerosol is generated in response to and in proportion with a user's puff strength/duration. The device finds particular application with Tobacco Heated Product (THP) devices. Previously proposed arrangements have tended to include a single heater to generate vapor for example from a reconstituted tobacco rod (taking a form similar to a combustible cigarette) which heats an entire tobacco rod to provide aerosol during a usage session. However a single larger heating element which heats a relatively large mass of consumable can take a reasonably long time (e.g., 40 seconds to a minute) to reach an operational temperature and begin vaporizing the consumable. Equally, it is quite difficult to rapidly change the temperature of heaters because heaters have a thermal response time comparable to or greater than the typical length of a puff.

The present technique is therefore based on the realization that puff response can be achieved in THP when using relatively smaller heaters arranged to heat relatively smaller patches of gel, whereby the thermal response time of the heater/system may be relatively quicker.

An example consumable is a flat substrate 110 as shown in FIGS. 3 and 5 (e.g., of paper/card) having a plurality of aerosol generating material (gel) portions 114 located on a surface thereof, each having a pre-defined mass. Each of the gel portions 114 may be heated by an individual heater 120 positioned below the flat substrate 110 or in close proximity according to an arrangement which may vary in accordance with physical characteristics of the aerosol provision device.

A more detailed arrangement is shown in FIG. 3 in which an exploded view is shown of the substrate 110 on which the portions of the aerosol generating material 114 are shown above the heating layer 112, which is shown above a control layer 113. It will be appreciated that the arrangement of the control layer 113, the heating layer 112 and the substrate 110 is for illustrative purposes only and may not conform to a practical configuration of an aerosol provision device embodying the disclosure.

Although the example shown in FIG. 3 shows separate portions, dots or discrete portions of the aerosol generating material, which form different regions, in other examples, the aerosol generating material may be a continuous deposit, sheet or medium and the different regions are different sections of a continuous or contiguous deposit of the aerosol generating material on the substrate.

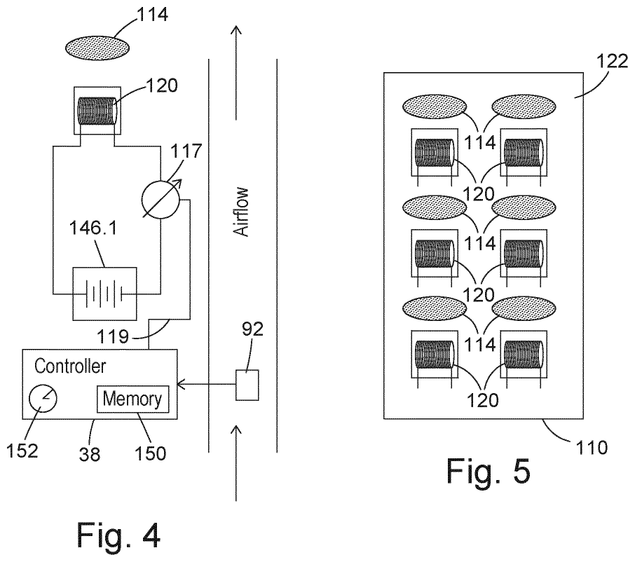

As shown in FIG. 3, the heating layer 112 includes a plurality of aerosol generating elements, each of the aerosol generating elements comprising a controllable cell 115. The heating layer 112 therefore provides adjacent each of the gel portions 114 in the substrate 110 a controllable cell which can generate heat for that gel portion. An example representation of one of the cells 115 is shown in FIG. 4. In FIG. 4, the cell is shown to comprise a heating element or heater 120 which is connected to a circuit which includes connection to a power supply 146.1 and a variable resistor or potentiometer 117 or similar device which can vary an amount of current supplied by the circuit to the heating element 120. A control channel or conductor 119 connects a control input on the potentiometer 117 to the controller 38. A signal applied to the control channel 119 from the controller 38 to the potentiometer 117 can vary an amount of current supplied to the heating element 120 from the power supply 146.1.

In the example described below, the source of energy for heating 120 is a heater, e.g., a resistive heater, which supplies energy (in the form of heat) to the aerosol generating medium to generate heat. The device 100 may have a plurality of chambers or regions that may or may not be separate from one another. The device 100 may have a power chamber (not shown) comprising a power source for supplying power to the source of energy for heating 120. The source of energy for heating 120 in the described example is an electrically resistive heater 120. However, in other examples, the source of energy for heating 120 may be a chemically activated heater which may or may not operate via exothermic reactions or the like. The source of energy for heating 120 may be part of an inductive heating system, wherein the source of energy for heating 120 is the source of energy for inductive heating, such as a coil of copper wire, and the substrate 110 may be or may contain a susceptor or the like. The susceptor may for example be a sheet of aluminum foil or the like. For the purposes of providing a concrete example, the source of energy for heating is herein described as a resistive heater, but it should be appreciated that references different heaters or heating system components are envisaged for use in the present device.

The heater 120 provides thermal energy, heat, to the surrounding environment of the heater 120. At least some portion of the substrate 110 is within the area of effect of the heater 120. The area of effect of the heater 120 is the area within which the heater 120 may provide heat to an item.

The substrate 110 of the present example includes aerosol generating medium disposed on a surface thereof. However, in other implementations, the substrate 110 may be formed exclusively of aerosol generating medium. In yet other implementations, the substrate 110 may have a layered structure from a plurality of materials. In one example, the substrate 110 may have a layer formed from at least one of thermally conductive material, inductive material, permeable material or impermeable material.

The source of aerosol generating medium may take any suitable form or construction. In one embodiment, the source of aerosol generating medium may include a substrate (for example, paper, card, foil) including a first and second side, with the aerosol generating medium disposed on the first side of the substrate. The substrate in this instance may act as a carrier for the aerosol generating medium. In some implementations, the substrate may be, or may include, a metallic element that is arranged to be heated by a varying magnetic field. In such implementations, the source of energy for heating 120 may include an induction coil, which, when energized, causes heating within the metallic element of the source 110. The degree of heating may be affected by the distance between the metallic element and the induction coil. In yet further alternative implementations, the source of aerosol generating medium may consist entirely (or substantially entirely) of aerosol generating medium (i.e., without a carrier). For the purposes of describing a concrete example, the source 110 described herein includes a substrate with aerosol generating medium disposed on the first side of the substrate, while the source of energy for heating 120 is herein a resistive heater.

In an example the aerosol forming material is disposed on the substrate 110 such that the distance from the source of energy for heating 120 to the aerosol forming material is within the range of 0.010 mm, 0.015 mm, 0.017 mm, 0.020 mm. 0.023 mm, 0.025 mm, 0.05 mm, 0.075 mm, 0.1 mm, to about 4 mm, 3.5 mm, 3 mm, 2.5 mm, 2.0 mm, 1.5 mm, 1.0 mm, 0.5 mm or 0.3 mm. In some cases, there may be a minimum spacing between the source of energy for heating 120 and aerosol forming material on the substrate 110 of at least about 10 μm, 15 μm, 17 μm, 20 μm, 23 μm, 25 μm, 50 μm, 75 μm or 0.1 mm.

Although the cell 115 shown in FIG. 4 includes the power supply 146.1 it will be appreciated that providing each cell with its own separate power supply 146.1 is just one example. Alternatively each cell could be connected to a single power supply such as the power supply 46.

The cell shown in FIG. 4 provides an individually controllable heater 120 which can be controlled by the controller 38 to produce an amount of heat provided to heat the gel portion 114. Since the substrate 110 includes a plurality of gel portions 114 and the heating layer 112 includes a corresponding number of cells with individual heaters 120 as illustrated in FIG. 5, the controller 38 can control the heaters in series or in parallel to cause one or more of the gel portions to generate an aerosol.

In certain embodiments, the controller 38 is configured to control the cells 110 of the heating layer to vary an amount of heat and therefore aerosol generated by a gel portion or portions 114 in response to and in proportion with an amount of air drawn by a user through the air channel 50, 72. The amount of air drawn though the air channel 50, 72 is detected by the air-flow sensor 92.

The air-flow sensor 92 could be a pressure transducer or an anemometer such as a hot wire anemometer, an acoustic sensor or a sensor which measures the cooling effect from water.

In one example, the power supply to the heater 120 of a cell can be varied in response to a strength of the user's puff, as measured by the air flow sensor 92. For example, a strength of the puff in terms of a magnitude of a signal detected by the air flow sensor 92 is proportional to an applied electrical power to the heater. Suppose a first puff causes a first power level P_{first} to be delivered to the heater 120 of a cell 110, a second puff causes a power level P_{second} to be supplied to the heater 120 of a cell. In the event that P_{second} is greater than P_{first}, a greater amount of aerosol can be generated more quickly because the greater power vaporizes the gel portion 114 relatively more quickly and generates relatively more aerosol per unit time. In the event that the puff duration as measured by the air flow sensor 92 is longer than the time necessary to vaporize all of a gel portion 114, then power can subsequently be applied to a second gel portion 114 by the heater 120 of another cell 110, while the heater 120 of the first cell 110 is turned off, to continue generating the aerosol for that puff. As a result of a configuration of the plurality of smaller heaters compared with a smaller number of larger heaters (e.g. one) the heaters have a relatively small mass. As a result, the heaters can reach operating temperature more quickly than a larger heater.

An amount of aerosol generated by each gel portion can be considered to be approximately proportional to an amount of cumulative energy applied to the gel portion from the power generated by the heater with respect to time. Therefore by recording an indication of an amount of power which is being applied to a gel portion over time, the controller 38 can be configured to estimate an amount of aerosol the gel portion will produce until exhausted and therefore an amount of aerosol remaining before the gel portion is exhausted. To this end, the controller 38 can include a memory for storing an amount of time for which an amount of heat has been applied to a gel portion 114, the time being measured with respect to a clock 150, 152. The recorded time and power can be used to calculate a cumulative amount of energy which has been applied to a gel portion 114 and therefore the amount of gel still remaining. Alternatively, the air flow sensor 92 can be used to determine an amount of air drawn through the air channel in the vicinity of the vapor generating region 73 to detect an amount of vapor generated by a gel portion, so that the controller 38 can activate the different cells and determine whether it is necessary to activate another gel portion if one becomes exhausted. In a second example, a heater 120 of a cell 115 can be operated to supply a fixed power P_{fixed} to provide a set amount of aerosol from a corresponding gel portion 114 per unit time. If a strength of a user's puff is stronger than a default puff strength, for which P_{fixed} has been correspondingly set, then an additional power P_{add} is simultaneously supplied to a heater 120 of a second of the plurality of cells 115 to generate an aerosol from a second portion of gel 114 to increase a total volume of aerosol entering the air channel supplied per unit time. Hence, P_{fixed}+P_{add} may be equal to P_{second} in the above example. However activating two heaters 120 from two different cells 115 in parallel can produce the aerosol more quickly than a single heater 120 from a single cell 115. This can also be thought of as increasing the surface area of the active part of the heater arrangement. As with the first example, if the duration of the puff is greater than the time necessary to deplete a gel portion 114, then another gel portion 114 can be heated to maintain the volume of aerosol per unit time generated.

In each example, the total amount of power supplied to the heater arrangement (or the active parts of the heater arrangement in contact with the gel) at any one time is proportional to the strength of the detected puff.

In another example, the user's previous puff data, as measured by the air flow sensor 92 e.g. strength, duration or frequency can be stored in a memory and then used to predict future puff behavior of the user e.g. the next puff to be taken. This means, the controller 38 can be configured to deliver a specific power level to the heater 120 of a cell 110 before the user takes a puff, so that the aerosol is ready immediately for inhalation by the user. Thus the controller 38 can be configured to activate the required number of cells to produce the predicted required volume of aerosol. Similarly to previous examples, if it is determined that the predicted puff will deplete the gel portion 14 before the end of the duration of the predicted puff, then another gel portion 14 can be heated to maintain the volume of aerosol predicted to be required.

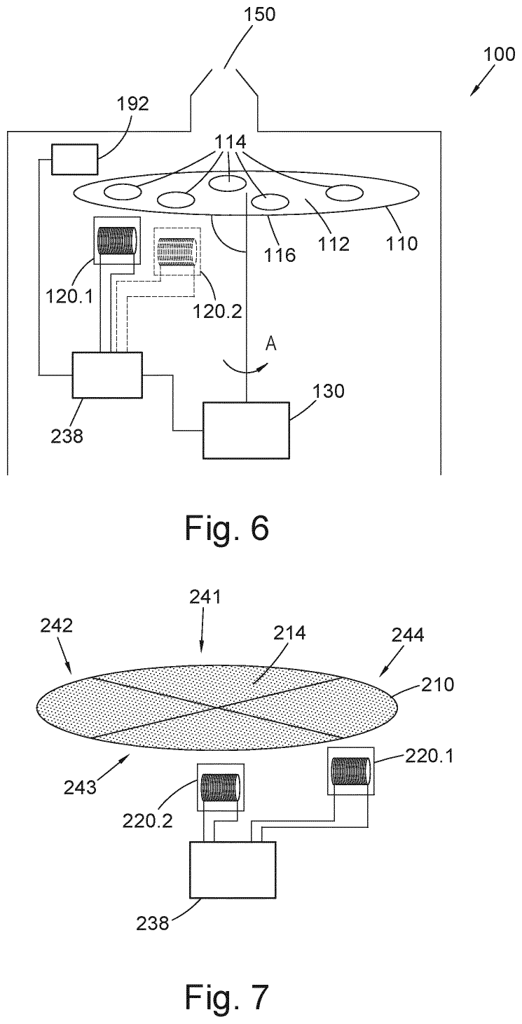

According to the example embodiments described above with reference to FIGS. 3, 4 and 5, each of the gel portions is provided with a corresponding cell 115 and a heater 120. However in other embodiments a single heating element may be provided and the gel portions moved with respect to the heater. Such an arrangement is disclosed in our co-pending UK patent application number 1904841.2 the contents of which are incorporated herein by reference. UK 1904841.2 discloses an aerosol provision device in which a plurality of gel portions on a substrate is rotated past a single heater. An example is shown in FIG. 6.

As for the example embodiments explained above with reference to FIGS. 3, 4 and 5, the example embodiment shown in FIG. 6 includes a substrate 110 within the device 100 which has a first surface 112 which has a plurality of gel portions 114 of aerosol generating medium disposed thereon. The substrate 110 has a second surface 116 which faces the first surface 112. The second surface 116 faces the first surface 112 and one or both of the first surface 112 and second surface 116 may be smooth or rough. As for the above examples, the device 100 has a source of energy for heating 120 arranged to face the second surface 116 of the substrate 110. The source of energy for heating 120 is an element of the aerosol provision device 100 which transfers energy from a power source, such as a battery (not shown), to the aerosol generating medium 114 to generate aerosol from the aerosol generating medium 114. The device 100 has a movement mechanism 130 arranged to move the substrate 110, and in particular portions 114 (or, in some cases, doses) of aerosol generating medium disposed thereon. The portions 114 of aerosol generating medium are rotationally movable relative to the heater 120 such that portions of the aerosol generating medium are presented, in this case individually, to the heater 120. The device 100 is arranged such that at least one portion 114 of the aerosol generating medium is rotated around an axis A at an angle θ to the second surface 116. The substrate 110 in this implementation is substantially flat. The substrate 110 in this implementation may be formed of partially or entirely of paper or card.

According to this example embodiment shown in FIG. 6, an amount of power supplied to the heater 120 and a rotation of the substrate is controlled by the controller 238 in response to a strength of a puff from the user as measured by an air flow sensor 192. That is to say that a signal indicative of an amount of air being drawn by the user through the aerosol provision device 100 generated by the air flow sensor 192 is fed to the controller 238 which controls an amount of heat produced by the heater 120 and therefore the amount of aerosol generated. As for the above example, an amount of power supplied to the heater 120 can be controlled to be proportional to the puff strength from the user as indicated by an amount of air drawn by the user. Therefore an amount of power supplied to the heater is controlled in proportion with the amount of air drawn. If a duration of a user's puff continues for a time which exceeds an amount of vapor which can be generated from a gel portion or a remaining amount of a gel portion then the controller 238 can control the rotation mechanism to rotate the substrate so that a new portion of the gel can be heated to generate vapor.

As will be appreciated for the example embodiment shown in FIG. 6, in contrast to the example embodiments presented in FIGS. 3, 4 and 5, with only a single heater, vapor can be only generated from one gel portion 114 at a time. However a plurality of heaters 120 can also be included with the aerosol provision device of FIG. 6 so that if there is a demand to increase an amount of vapor included in an aerosol generated in proportion to a user's puff strength or duration of a user's puff then more than one heater can be activated.

The above embodiments have been described with respect to a plurality of discrete gel portions in which one or more discrete heaters are used to heat a single gel portion which may be continuous or dis-continuous. However, in other examples, the gel may be continuous and multiple heaters could be used to vaporize the gel. For instance, in the case of the second example embodiments with reference to FIG. 6, a heater surface may be split into segments, which may either be activated or not based on the strength of the user's puff, or they may already be activated and moved towards/away from the consumable. One example is shown in FIG. 7 in which the gel 214 is formed on a disk shaped substrate 210. Two heating elements 220.1, 220.2 are arranged below different sections 243, 244 of the gel into which a continuous surface of the gel is divided 241, 242, 243, 244. As for the example of FIG. 6, the substrate can be rotated as the gel sections are exhausted.

In some examples, a humidity sensor is also included to determine an amount of water vapor in surrounding air, which is used by the controller 238 to adjust an amount of heat applied to a gel portion or adjust an estimate of an amount of the gel remaining before activating another gel portion. Air humidity can affect a rate at which vapor is generated when heat is applied to a gel portion to form an aerosol. As such a user may need to draw more air depending on the air humidity. Therefore by estimating a measure of the air humidity, the controller can determine more accurately an amount of gel remaining in the gel portion with respect to an amount of heat (energy) already imparted to the gel portion and therefore when it is necessary to switch to a new gel portion.

According to the above examples, the controller 38 manages the heating elements 120, 120.1, 120.2 to generate the vapor from the gel portions in an open loop manner in the sense that the estimate of an amount of vapor generated from a gel portion is determined without directly measuring whether the vapor is being produced by a gel portion. This can provide a more simple arrangement for controlling the heating elements to generate the vapor, but may have a disadvantage in that a manufacturing tolerance for a consumable which includes the gel portions may be required to be high in order to avoid gel portions either being exhausted before the controller switches to a new gel portion 114 or the controller switching to a new gel portion when gel in a previous portion still remains.

As will be appreciated, in other example embodiments a detector may be used to provide an estimate of vapor produced from the gel in the aerosol and therefore to detect when a gel portion has been exhausted and stops generating vapor, before or during switching. One example of such a detector is an optical obstruction or turbidity type sensor in which the amount of vapor present is determined from an amount of light absorbed.

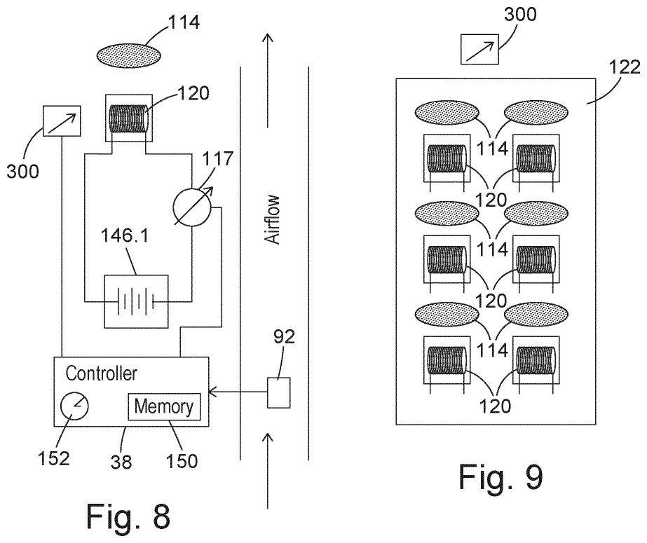

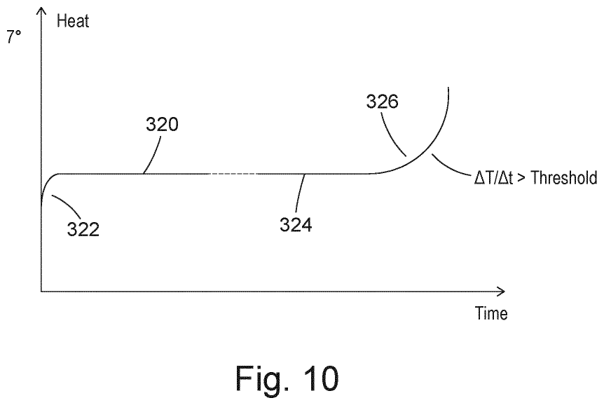

As a further example embodiment a temperature sensor could be provided proximate the heating elements or a temperature sensor could be provided for each heating element. Such example embodiments are shown in FIGS. 8 and 9, which correspond to the examples of FIGS. 4 and 5. As shown in FIG. 8, each of the controllable cells includes a temperature sensor 300, which is connected the controller 38. The temperature sensor can therefore measure the temperature in or around the gel portion 114. An alternative is shown in FIG. 9 in which a single temperature sensor 300 is provided for the plurality of controllable cells with associated gel portions 114. For the arrangement in FIG. 9, it may be sufficient for a temperature sensor 300 to be disposed in the vicinity of the consumable. According to these example embodiments, the temperature sensor or sensors 300 can be used to detect a rate of change of temperature. As will be appreciated, whilst there is gel in a gel portion 114, the temperature in the vicinity of the gel portion will remain substantially constant, because the gel is absorbing the heat as the heat energy is being converted into vapor, however once the vapor is exhausted the temperature around the heater will increase rapidly. An example is illustrated graphically in FIG. 9, which shows a plot 320 of temperature with respect to time. During a first section there is an increase in temperature until a gel portion 114 begins to generate vapor. After the heater 120 reaches an ambient temperature and the gel is generating vapor the temperature around the gel portion remains relatively constant as shown in section 324. However as the gel is exhausted the heat begins to rise with time as shown in a section 326. By comparing the rate of change of temperature with respect to time ΔT/Δt with a threshold, the controller 38 can detect when the gel portion has become exhausted. Accordingly the controller 38 can be configured to detect if the rate of change of the temperature exceeds a predefined limit corresponding to an exhaustion of the gel and then switch off the heater and switch to another gel portion.

In further example embodiments an aerosol provision system for generating aerosol for user inhalation may comprise a replaceable part 24 and a reusable part 22. The replaceable part 24 comprises a housing and a substrate 110 disposed within the housing, the substrate 110 comprising aerosol generating material 114 for generating the aerosol for user inhalation. The reusable part 22 comprises a housing 32 including an interface configured to operatively engage with the replaceable part 24, and an air channel configured at least partially in the housing to provide a passage of air drawn by the user to receive the aerosol generated from the aerosol generating material, a detector 92 for detecting the passage of air drawn through the air channel; an aerosol generating element disposed with respect to the interface and configured, in use, to generate aerosol from the aerosol generating material, and a control circuit 38. The control circuit is configured to receive a signal from the detector indicating an amount of air drawn by the user and to control the aerosol generating element in response to the detector detecting the amount of air through the air channel to generate the aerosol in proportion to the amount of air drawn by the user through the air channel. As indicated above, the aerosol generating material may be an amorphous solid, such as a gel or the like.

In some examples, the aerosol generating element may be a heater and the control circuit is configured to control an amount of heat generated by the heater in proportion to an amount of air drawn by the user through the air channel to generate the aerosol from the aerosol generating material in accordance with an amount of air drawn by the user through the air channel.

In some embodiments, the non-combustible aerosol provision system is an electronic cigarette, also known as a vaping device or electronic nicotine delivery system (END), although it is noted that the presence of nicotine in the aerosol generating material is not a requirement.

In some embodiments, the non-combustible aerosol provision system is a tobacco heating system, also known as a heat-not-burn system.

In some embodiments, the non-combustible aerosol provision system is a hybrid system to generate aerosol using a combination of aerosol generating materials, one or a plurality of which may be heated. Each of the aerosol generating materials may be, for example, in the form of a solid, liquid or gel and may or may not contain nicotine. In some embodiments, the hybrid system comprises a liquid or gel aerosol generating material and a solid aerosol generating material. The solid aerosol generating material may comprise, for example, tobacco or a non-tobacco product.

Typically, the non-combustible aerosol provision system may comprise a non-combustible aerosol provision device and an article for use with the non-combustible aerosol provision device. However, it is envisaged that articles which themselves comprise a means for powering an aerosol generating component may themselves form the non-combustible aerosol provision system.

In some embodiments, the non-combustible aerosol provision device may comprise a power source and a controller. The power source may, for example, be an electric power source.

In some embodiments, the article for use with the non-combustible aerosol provision device may comprise an aerosol generating material, an aerosol generating component, an aerosol generating area, a mouthpiece, and/or an area for receiving aerosol generating material.

In some embodiments, the aerosol generating component is a heater capable of interacting with the aerosol generating material so as to release one or more volatiles from the aerosol generating material to form an aerosol.

In some embodiments, the substance to be delivered may be an aerosol generating material. Aerosol generating material, which also may be referred to herein as aerosol generating material, is material that is capable of generating aerosol, for example when heated, irradiated or energized in any other way. Aerosol generating material may, for example, be in the form of a solid, liquid or gel which may or may not contain nicotine and/or flavorants. In some embodiments, the aerosol generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol generating material may for example comprise from about 50 wt %, 60 wt % or 70 wt % of amorphous solid, to about 90 wt %, 95 wt % or 100 wt % of amorphous solid.

In some embodiments, the aerosol generating material may comprise one or more polyhydric alcohols, such as propylene glycol, triethylene glycol, 1,3-butanediol and glycerin; esters of polyhydric alcohols, such as glycerol mono-, di- or triacetate; and/or aliphatic esters of mono-, di- or polycarboxylic acids, such as dimethyl dodecanedioate and dimethyl tetradecanedioate.

In certain embodiments, the aerosol-generating material comprises a gelling agent comprising a cellulosic gelling agent and/or a non-cellulosic gelling agent, an active substance and an acid.

The gelling agent may comprise one or more compounds selected from cellulosic gelling agents, non-cellulosic gelling agents, guar gum, acacia gum and mixtures thereof.

In some embodiments, the cellulosic gelling agent is selected from the group consisting of: hydroxymethyl cellulose, hydroxyethyl cellulose, hydroxypropyl cellulose, carboxymethylcellulose (CMC), hydroxypropyl methylcellulose (HPMC), methyl cellulose, ethyl cellulose, cellulose acetate (CA), cellulose acetate butyrate (CAB), cellulose acetate propionate (CAP) and combinations thereof.

In some embodiments, the gelling agent comprises (or is) one or more of hydroxyethyl cellulose, hydroxypropyl cellulose, hydroxypropyl methylcellulose (HPMC), carboxymethylcellulose, guar gum, or acacia gum.

In some embodiments, the gelling agent comprises (or is) one or more non-cellulosic gelling agents, including, but not limited to, agar, xanthan gum, gum Arabic, guar gum, locust bean gum, pectin, carrageenan, starch, alginate, and combinations thereof. In some embodiments, the non-cellulose based gelling agent is alginate or agar.

The aerosol-generating material may comprise an acid. The acid may be an organic acid. In some of these embodiments, the acid may be at least one of a monoprotic acid, a diprotic acid and a triprotic acid. In some such embodiments, the acid may contain at least one carboxyl functional group. In some such embodiments, the acid may be at least one of an alpha-hydroxy acid, carboxylic acid, dicarboxylic acid, tricarboxylic acid and keto acid. In some such embodiments, the acid may be an alpha-keto acid.

In some such embodiments, the acid may be at least one of succinic acid, lactic acid, benzoic acid, citric acid, tartaric acid, fumaric acid, levulinic acid, acetic acid,

malic acid, formic acid, sorbic acid, benzoic acid, propanoic and pyruvic acid.

Suitably the acid is lactic acid. In other embodiments, the acid is benzoic acid. In other embodiments the acid may be an inorganic acid. In some of these embodiments the acid may be a mineral acid. In some such embodiments, the acid may be at least one of sulphuric acid, hydrochloric acid, boric acid and phosphoric acid. In some embodiments, the acid is levulinic acid.

The inclusion of an acid is in some embodiments in which the aerosol-generating material comprises nicotine. In such embodiments, the presence of an acid may stabilize dissolved species in the slurry from which the aerosol-generating material is formed. The presence of the acid may reduce or substantially prevent evaporation of nicotine during drying of the slurry, thereby reducing loss of nicotine during manufacturing.

In some embodiments, the aerosol-generating material comprises one or more cannabinoid compounds selected from the group consisting of: cannabidiol (CBD), tetrahydrocannabinol (THC), tetrahydrocannabinolic acid (THCA), cannabidiolic acid (CBDA), cannabinol (CBN), cannabigerol (CBG), cannabichromene (CBC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM) and cannabielsoin (CBE), cannabicitran (CBT).

The aerosol-generating material may comprise one or more cannabinoid compounds selected from the group consisting of cannabidiol (CBD) and THC (tetrahydrocannabinol).

The aerosol-generating material may comprise cannabidiol (CBD).

The aerosol-generating material may comprise nicotine and cannabidiol (CBD).

The aerosol-generating material may comprise nicotine, cannabidiol (CBD), and THC (tetrahydrocannabinol).

The aerosol generating material may comprise one or more active constituents, one or more carrier constituents and optionally one or more other functional constituents.

The active constituent may comprise one or more physiologically and/or olfactory active constituents which are included in the aerosol generating material in order to achieve a physiological and/or olfactory response in the user. The active constituent may for example be selected from nutraceuticals, nootropics, and psychoactives. The active constituent may be naturally occurring or synthetically obtained. The active constituent may comprise for example nicotine, caffeine, taurine, or any other suitable constituent. The active constituent may comprise a constituent, derivative or extract of tobacco or of another botanical. In some embodiments, the active constituent is a physiologically active constituent and may be selected from nicotine, nicotine salts (e.g. nicotine ditartrate/nicotine bitartrate), nicotine-free tobacco substitutes, other alkaloids such as caffeine.

In some embodiments, the active constituent is an olfactory active constituent and may be selected from a “flavor” and/or “flavorant” which, where local regulations permit, may be used to create a desired taste, aroma or other somatosensorial sensation in a product for adult consumers. In some instances such constituents may be referred to as flavors, flavorants, cooling agents, heating agents, or sweetening agents. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gasone or more of extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, or powder.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3.

The carrier constituent may comprise one or more constituents capable of forming an aerosol. In some embodiments, the carrier constituent may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional constituents may comprise one or more of pH regulators, coloring agents, preservatives, binders, fillers, stabilizers, and/or antioxidants.

In some embodiments, the article for use with the non-combustible aerosol provision device may comprise aerosol generating material or an area for receiving aerosol generating material. In some embodiments, the article for use with the non-combustible aerosol provision device may comprise a mouthpiece. The area for receiving aerosol generating material may be a storage area for storing aerosol generating material. For example, the storage area may be a reservoir. In some embodiments, the area for receiving aerosol generating material may be separate from, or combined with, an aerosol generating area.

While the above-described embodiments have in some respects focused on some specific example aerosol provision systems, it will be appreciated the same principles can be applied for aerosol provision systems using other technologies. That is to say, the specific manner in which various aspects of the aerosol provision system function are not directly relevant to the principles underlying the examples described herein.

For example, whereas the above-described embodiments have primarily focused on aerosol provision systems comprising a vaporizer comprising a resistance heater coil, in other examples the vaporizer may comprise other forms of heater, for example a planar heater, in contact with a liquid transport element. Furthermore, in other implementations a heater-based vaporized might be inductively heated. In yet other examples, the principles described above may be adopted in devices which do not use heating to generate vapor, but use other vaporization technologies, for example piezoelectric excitement.

Furthermore, and as already noted, whereas the above-described embodiments have focused on approaches in which the aerosol provision system comprises a two-part device, the same principles may be applied in respect of other forms of aerosol provision system which do not rely on replaceable cartridges, for example refillable or one-time use devices.

Thus there has been described an aerosol provision system for generating aerosol for user inhalation. The aerosol provision system comprises a replaceable part 24, the replaceable part comprising a housing providing an air channel 72 and a substrate 110 disposed within the air channel, the substrate 110 comprising aerosol generating material 114 for generating the aerosol for user inhalation; and a reusable part 22. The reusable part comprises a housing 32 including an interface configured to operatively engage with the replaceable part 24, and an air channel configured at least partially in the housing and to connect to the air channel of the replaceable part to provide a passage of air drawn by the user to receive the aerosol generated from the aerosol generating material, a detector 92 for detecting the passage of air drawn through the air channel; at least one aerosol generating element disposed with respect to the interface and configured, in use, to generate aerosol from the aerosol generating material, and a control circuit 38. The control circuit is configured to receive a signal from the detector indicating an amount of air drawn by the user and to control the at least one aerosol generating element in response to the detector detecting the amount of air through the air channel, wherein the at least one aerosol generating element is configured with respect to the substrate of the replaceable part to generate aerosol selectively from different regions of the aerosol generating material in accordance with the amount of air drawn by the user to generate a selectable amount of the aerosol. In this example the replaceable part includes an air channel.

The heater may comprise one or more electrically resistive heaters, including for example one or more nichrome resistive heater(s) and/or one or more ceramic heater(s). The one or more heaters may comprise one or more induction heaters which includes an arrangement comprising one or more susceptors which may form a chamber into which an article comprising aerosolizable material is inserted or otherwise located in use. Alternatively or in addition, one or more susceptors may be provided in the aerosolisable aerosolizable material. Other heating arrangements may also be used.

In order to address various issues and advance the art, this disclosure shows by way of illustration various embodiments in which the disclosure may be practiced. The advantages and features of the disclosure are of a representative sample of embodiments only, and are not exhaustive and/or exclusive. They are presented only to assist in understanding and to teach the disclosure. It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include inventions not presently claimed, but which may be claimed in future.

The following numbered paragraphs provide further example aspects and features of the present disclosure:

Paragraph 1. An aerosol provision system for generating aerosol for user inhalation, the aerosol provision system comprising:
a replaceable part (24) comprising a substrate (110), the substrate (110) comprising aerosol generating material (114) for generating the aerosol for user inhalation; and

a reusable part (22) comprising

a housing (32) including an interface configured to operatively engage with the replaceable part (24), and an air channel configured at least partially in the housing to provide a passage of air drawn by the user to receive the aerosol generated from the aerosol generating material,

a detector (92) for detecting the passage of air drawn through the air channel;

at least one aerosol generating element disposed with respect to the interface and configured, in use, to generate aerosol from the aerosol generating material, and

a control circuit (38) configured to receive a signal from the detector indicating an amount of air drawn by the user and to control the at least one aerosol generating element to generate the aerosol selectively from different regions of the aerosol generating material in response to the amount of air drawn through the air channel.

Paragraph 2. The aerosol provision system according to paragraph 1, wherein the control circuit (38) is configured to generate selectively the aerosol from the different regions (114) of the substrate (110) in response to one or both of the amount of air drawn by the user through the air channel and a duration of a draw of air through the air channel.

Paragraph 3. The aerosol provision system according to paragraph 1 or 2, wherein the substrate is moveable with respect to the at least one aerosol generating element and the control circuit (38) is configured to control movement of the substrate with respect to the at least one aerosol generating element to generate the aerosol from the aerosol generating material on the substrate in response to one or both of the amount of air drawn by the user through the air channel and the duration of a draw of air through the air channel.

Paragraph 4. The aerosol provision system according to paragraph 1 or 2, wherein the reusable part (22) includes a movement mechanism (130) configured to engage with the substrate (110) when the replaceable part (22) is mounted on the reusable part (24) and the control circuit (38) is configured to control the movement mechanism to move the substrate with respect to the at least one aerosol generating element to generate the aerosol from the different regions of the aerosol generating material.

Paragraph 5. The aerosol provision system according to paragraph 4, wherein the control circuit is configured to determine an amount of aerosol generated by each region of the aerosolizable aerosol generating material and to move the substrate when the region has become exhausted to generate aerosol from a different region.

Paragraph 6. The aerosol provision system according to any of paragraphs 1 or 4, wherein the at least one aerosol generating element comprises a plurality of aerosol generating elements each of which is spatially positioned with respect to the substrate so that when activated each of the plurality of aerosol generating elements can generate aerosol from a different region of the aerosol generating material, and the control circuit is configured to activate one or more of the plurality of aerosol generating elements separately in response to the user drawing air through the air channel to generate the aerosol on the substrate in response to one or both of the amount of air drawn by the user through the air channel and the duration of a draw of air through the air channel.

Paragraph 7. The aerosol provision system according to paragraph 6, wherein the control circuit is configured to control the plurality of aerosol generating elements to activate more than one of the aerosol generating elements if the amount of air drawn by the user through the air channel exceeds a predetermined threshold.

Paragraph 8. The aerosol provision system according to paragraph 6, wherein the control circuit is configured to control the plurality of aerosol generating elements to activate a first of the plurality of the aerosol generating elements in response to the detector detecting air being drawn though the air channel and if air is drawn through the air channel by the user for a time duration which exceeds a threshold time then activating a second of the aerosol generating elements.

Paragraph 9. The aerosol provision system according to paragraph 8, wherein the control circuit is configured to determine an amount of aerosol generated by each region of the aerosolizable aerosol generating material and to activate the second of the aerosol generating elements when the duration of the draw of air by the user through the air channel is greater than or equal to the threshold time, the threshold time being determined from an activation time of the first of the aerosol generating elements to exhaust the region of aerosolizable aerosol generating material.

Paragraph 10. The aerosol provision system according to paragraph 8, wherein each of the plurality of aerosol generating elements comprises a cell which includes a controllable heating element connected to the control circuitry.

Paragraph 11. The aerosol provision system according to paragraph 6, wherein each of the plurality of aerosol generating elements comprises a cell which includes a controllable heating element connected to the control circuitry, the aerosol generating material being responsive to heat to generate the aerosol, and the system includes at least one temperature sensor disposed with respect to the plurality of heating elements to estimate a temperature of the heater and/or the aerosol generating material, and the control circuit is configured to control the plurality of aerosol generating elements to activate a first of the plurality of heaters in response to the detector detecting air being drawn though the air channel and to activate a second of the plurality of heaters in response to the estimated temperature.

Paragraph 12. The aerosol provision system according to paragraph 11, wherein the control circuit is configured to control the plurality of aerosol generating elements to activate the second of the plurality of heaters in response to the estimated temperature if a rate of change of temperature with respect to time exceeds a predetermined threshold.

Paragraph 13. The aerosol provision system according to paragraph 12, wherein the control circuit is configured to control the plurality of aerosol generating elements to activate the second of the plurality of heaters in response to the estimated temperature if the estimated temperature exceeds a predetermined threshold.

Paragraph 14. The aerosol provision system according to paragraph 11, 12 or 13, wherein the at least one temperature sensor comprises a plurality of temperature sensors, each of the plurality of temperature sensors being disposed to estimate a temperature of one of the plurality of heaters.

Paragraph 15. The aerosol provision system according to any of paragraphs 1 to 14, wherein the replaceable part includes a housing is configured with an air channel and the substrate is disposed with respect to the air channel, so that air drawn by the user through the replaceable part and the reusable part causes the aerosol to be drawn through the air channel of the replaceable part for user inhalation.

Paragraph 16. A reusable part of an aerosol provision system for generating an aerosol for user inhalation, the reusable part (22) comprising

a housing (32) including an interface configured to operatively engage with a replaceable part (24), the replaceable part including a substrate (110) comprising aerosol generating material (114) for generating the aerosol for user inhalation,

an air channel configured at least partially in the housing to provide a passage of air drawn by the user to receive the aerosol generated from the aerosol generating material of the replaceable part disposed with respect to the air channel,

a detector (92) for detecting the passage of air drawn through the air channel;

at least one aerosol generating element disposed with respect to the interface and configured, in use, to generate the aerosol from the aerosol generating material, and

a control circuit (38) configured

to receive a signal from the detector (92) indicating an amount of air drawn by the user, and

to control the at least one aerosol generating element to generate the aerosol selectively from different regions of the aerosol generating material in response to the amount of air drawn through the air channel.

Paragraph 17. The reusable part according to paragraph 16, wherein the control circuit (38) is configured to generate selectively the aerosol from the different regions (114) of the substrate (110) in response to one or both of the amount of air drawn by the user through the air channel and a duration of a draw of air through the air channel.

Paragraph 18. The reusable part according to paragraph 16 or 17, wherein the substrate is moveable with respect to the at least one aerosol generating element and the control circuit (38) is configured to control movement of the substrate with respect to the at least one aerosol generating element to generate the aerosol from the aerosol generating material on the substrate in response to one or both of the amount of air drawn by the user through the air channel and the duration of a draw of air through the air channel.

Paragraph 19. The reusable part according to any of paragraphs 16 to 18, wherein the reusable part (22) includes a movement mechanism (130) configured to engage with the substrate (110) when the replaceable part (22) is mounted on the reusable part (24) and the control circuit (38) is configured to control the movement mechanism to move the substate with respect to the at least one aerosol generating element to generate the aerosol from the different regions of the aerosol generating material.

Paragraph 20. The reusable part according to paragraph 19, wherein the control circuit is configured to determine an amount of aerosol generated by each region of the aerosol generating material and to move the substrate when the region has become exhausted to generate aerosol from a different region.

Paragraph 21. The reusable part according to any of paragraphs 16 or 20, wherein the at least one aerosol generating element comprises a plurality of aerosol generating elements each of which is spatially positioned with respect to the substrate so that when activated each of the plurality of aerosol generating elements can generate aerosol from a different region of the aerosol generating material, and the control circuit is configured to activate one or more of the plurality of aerosol generating elements separately in response to the user drawing air through the air channel to generate the aerosol selectively from the different regions of the aerosol generating material in response to one or both of the amount of air drawn by the user through the air channel and the duration of a draw of air through the air channel.

Paragraph 22. The reusable part according to paragraph 21, wherein the control circuit is configured to control the plurality of aerosol generating elements to activate more than one of the aerosol generating elements if the amount of air drawn by the user through the air channel exceeds a predetermined threshold.

Paragraph 23. The reusable part according to paragraph 21, wherein the control circuit is configured to control the plurality of aerosol generating elements to activate a first of the plurality of the aerosol generating elements in response to the detector detecting air being drawn though the air channel and if air is drawn through the air channel by the user for a time duration which exceeds a threshold time then activating a second of the aerosol generating elements.

Paragraph 24. The reusable part according to paragraph 23, wherein the control circuit is configured to determine an amount of aerosol generated by each region of the aerosol generating material and to activate the second of the aerosol generating elements when the duration of the draw of air by the user through the air channel is greater than or equal to the threshold time, the threshold time being determined from an activation time of the first of the aerosol generating elements to exhaust the region of aerosol generating material.

Paragraph 25. The reusable part according to paragraph 23, wherein each of the plurality of aerosol generating elements comprises a cell which includes a controllable heating element connected to the control circuitry.

Paragraph 26. The reusable part according to paragraph 25, wherein each of the plurality of aerosol generating elements comprises a cell which includes a controllable heating element connected to the control circuitry, the aerosol generating material being responsive to heat to generate the aerosol, and the system includes at least one temperature sensor disposed with respect to the plurality of heating elements to estimate a temperature of the heater and/or the aerosol generating material, and the control circuit is configured to control the plurality of aerosol generating elements to activate a first of the plurality of heaters in response to the detector detecting air being drawn though the air channel and to activate a second of the plurality of heaters in response to the estimated temperature.

Paragraph 27. The reusable part according to paragraph 26, wherein the control circuit is configured to control the plurality of aerosol generating elements to activate the second of the plurality of heaters in response to the estimated temperature if a rate of change of temperature with respect to time exceeds a predetermined threshold.

Paragraph 28. The reusable part according to paragraph 27, wherein the control circuit is configured to control the plurality of aerosol generating elements to activate the second of the plurality of heaters in response to the estimated temperature if the estimated temperature exceeds a predetermined threshold.

Paragraph 29. The reusable part according to paragraph 26, 27 or 28, wherein the at least one temperature sensor comprises a plurality of temperature sensors, each of the plurality of temperature sensors being disposed to estimate a temperature of one of the plurality of heaters.

Paragraph 30. A replaceable part (24) for an aerosol provision system for generating aerosol for user inhalation, the replaceable part comprising a housing and a substrate (110) disposed within the housing, the substrate (110) comprising a plurality of portions of aerosol generating material (114) for generating the aerosol for user inhalation, wherein the replaceable part is configured to engage with an interface of a reusable part providing a plurality of aerosol generating elements each of which is disposed via the interface adjacent one of the plurality of aerosol generating portions when the replaceable part is engaged via the interface with the reusable part, wherein, in use, the plurality of aerosol generating elements are configured with respect to the substrate of the replaceable part to generate aerosol selectively from different regions of the aerosol generating material in accordance with the amount of air drawn by the user to generate a selectable amount of the aerosol.

Paragraph 31. The replaceable part (24) according to paragraph 1, wherein the housing is configured with an air channel and the substrate is disposed with respect to the air channel so that air drawn by the user through the air channel of the replaceable part when engaged with the reusable part causes the aerosol to be drawn through the air channel of the replaceable part for user inhalation.

Paragraph 32. An aerosol provision system for generating aerosol for user inhalation, the aerosol provision system comprising:
a replaceable part (24), the replaceable part comprising a housing and a substrate (110) disposed within the housing, the substrate (110) comprising aerosol generating material (114) for generating the aerosol for user inhalation; and

a reusable part (22) comprising

a housing (32) including an interface configured to operatively engage with the replaceable part (24), and an air channel configured at least partially in the housing to provide a passage of air drawn by the user to receive the aerosol generated from the aerosol generating material,

a detector (92) for detecting the passage of air drawn through the air channel;

an aerosol generating element disposed with respect to the interface and configured, in use, to generate aerosol from the aerosol generating material, and

a control circuit (38) configured to receive a signal from the detector indicating an amount of air drawn by the user and to control the aerosol generating element in response to the detector detecting the amount of air through the air channel to generate the aerosol in proportion to the amount of air drawn by the user through the air channel.

Paragraph 33. The aerosol provision system according to paragraph 32, wherein the aerosol generating material is an amorphous solid.

Paragraph 34. The aerosol provision system according to paragraph 32, wherein the aerosol generating material is a gel.

Paragraph 35. The aerosol provision system according to paragraph 32, wherein the aerosol generating element is a heater and the control circuit is configured to control an amount of heat generated by the heater in proportion to an amount of air drawn by the user through the air channel to generate the aerosol from the aerosol generating material in accordance with an amount of air drawn by the user through the air channel.

Paragraph 36. The aerosol provision system according to any of paragraphs 32 to 35, wherein the aerosol generating element comprises a plurality of heating elements configured with respect to the substrate of the replaceable part to generate aerosol selectively from different regions of the aerosol generating material in accordance with the amount of air drawn by the user to generate a selectable amount of the aerosol.

1. An aerosol provision system for generating aerosol for user inhalation, the aerosol provision system comprising:
a replaceable part comprising a substrate providing aerosol generating material for generating the aerosol for user inhalation; and
a reusable part comprising:
a housing including an interface configured to operatively engage with the replaceable part, and an air channel configured at least partially in the housing to provide a passage of air drawn by user inhalation to receive the aerosol generated from the aerosol generating material,
a detector configured to detect the passage of air drawn through the air channel;
at least one aerosol generating element disposed with respect to the interface and configured, in use, to generate aerosol from the aerosol generating material, and
a control circuit configured to receive a signal from the detector indicating an amount of air drawn by the user and to control the at least one aerosol generating element to generate the aerosol selectively from different regions of the aerosol generating material in response to the amount of air drawn through the air channel.

2. The aerosol provision system according to claim 1, wherein the control circuit is configured to generate the aerosol selectively from the different regions of the aerosol generating material in response to one or both of the amount of air drawn by the user through the air channel and a duration of a draw of air through the air channel by the user.

3. The aerosol provision system according to claim 1, wherein the substrate is moveable with respect to the at least one aerosol generating element and the control circuit is configured to control movement of the substrate with respect to the at least one aerosol generating element to generate the aerosol from the different regions of the aerosol generating material on the substrate in response to one or both of the amount of air drawn by the user through the air channel and a duration of a draw of air through the air channel.

4. The aerosol provision system according to claim 1, wherein the reusable part includes a movement mechanism configured to engage with the substrate when the replaceable part is mounted on the reusable part and the control circuit is configured to control the movement mechanism to move the substrate with respect to the at least one aerosol generating element to generate the aerosol selectively from the different regions of the aerosol generating material.

5. The aerosol provision system according to claim 4, wherein the control circuit is configured to determine an amount of aerosol generated by each region of the aerosol generating material and to move the substrate when the region has become exhausted to generate the aerosol from a different region.

6. The aerosol provision system according to claim 1, wherein the at least one aerosol generating element comprises a plurality of aerosol generating elements each of which is spatially positioned with respect to the substrate so that when activated each of the plurality of aerosol generating elements can generate the aerosol selectively from the different regions of the aerosol generating material, and the control circuit is configured to activate one or more of the plurality of aerosol generating elements separately in response to the user drawing air through the air channel to generate the aerosol selectively from the different regions of the aerosol generating material in response to one or both of the amount of air drawn by the user through the air channel and a duration of a draw of air through the air channel.

7. The aerosol provision system according to claim 6, wherein the control circuit is configured to control the plurality of aerosol generating elements to activate more than one of the aerosol generating elements if the amount of air drawn by the user through the air channel exceeds a predetermined threshold amount.

8. The aerosol provision system according to claim 6, wherein the control circuit is configured to control the plurality of aerosol generating elements to activate a first of the plurality of the aerosol generating elements in response to the detector detecting air being drawn though the air channel and if the air is drawn through the air channel by the user for a time duration which exceeds a predetermined threshold time then the control circuit is configured to activate a second of the plurality of the aerosol generating elements.

9. The aerosol provision system according to claim 8, wherein the control circuit is configured to determine an amount of aerosol generated by each region of the aerosol generating material and to activate the second of the aerosol generating elements when the duration of the air drawn by the user through the air channel is greater than or equal to the threshold time, the threshold time being determined from an activation time of one of the first of the aerosol generating elements to exhaust a region of aerosol generating material.

10. The aerosol provision system according to claim 8, wherein each of the plurality of aerosol generating elements comprises a cell which includes a controllable heating element connected to the control circuit

11. The aerosol provision system according to claim 6, wherein each of the plurality of aerosol generating elements comprises a cell which includes a controllable heating element connected to the control circuit, the aerosol generating material being responsive to heat generated by a corresponding one of the plurality of the heating elements to generate the aerosol, and the system includes at least one temperature sensor disposed with respect to the plurality of heating elements to estimate a temperature of the heater and/or the aerosol generating material, and the control circuit is configured to control the plurality of aerosol generating elements to activate a first of the plurality of heaters in response to the detector detecting air being drawn though the air channel and to activate a second of the plurality of heaters in response to the estimated temperature.

12. The aerosol provision system according to claim 11, wherein the control circuit is configured to control the plurality of aerosol generating elements to activate the second of the plurality of heaters in response to the estimated temperature if a rate of change of temperature with respect to time exceeds a predetermined rate of change.

13. The aerosol provision system according to claim 12, wherein the control circuit is configured to control the plurality of aerosol generating elements to activate the second of the plurality of heaters in response to the estimated temperature if the estimated temperature exceeds a set threshold temperature.

14. The aerosol provision system according to claim 11 wherein the at least one temperature sensor comprises a plurality of temperature sensors, each of the plurality of temperature sensors being disposed to estimate a temperature of one of the plurality of heaters.

15. The aerosol provision system according to claim 1, wherein the replaceable part comprises a housing configured with an air channel and the substrate is disposed with respect to the air channel, so that air drawn by the user through the replaceable part and the reusable part causes the aerosol to be drawn through the air channel of the replaceable part for user inhalation.

16. A reusable part of an aerosol provision system for generating an aerosol for user inhalation, the reusable part comprising
a housing including an interface configured to operatively engage with a replaceable part, the replaceable part including a substrate comprising aerosol generating material for generating the aerosol for user inhalation,
an air channel configured at least partially in the housing to provide a passage of air drawn by the user to receive the aerosol generated from the aerosol generating material of the replaceable part disposed with respect to the air channel,
a detector for detecting the passage of air drawn through the air channel;
at least one aerosol generating element disposed with respect to the interface and configured, in use, to generate the aerosol from the aerosol generating material, and
a control circuit configured
to receive a signal from the detector indicating an amount of air drawn by the user, and
to control the at least one aerosol generating element to generate the aerosol selectively from different regions of the aerosol generating material in response to the amount of air drawn through the air channel.

17. The reusable part according to claim 16, wherein the control circuit is configured to generate the aerosol selectively from the different regions of the aerosol generating material in response to one or both of the amount of air drawn by the user through the air channel and a duration of a draw of air through the air channel by the user.

18. The reusable part according to claim 16, wherein the substrate is moveable with respect to the at least one aerosol generating element and the control circuit is configured to control movement of the substrate with respect to the at least one aerosol generating element to generate the aerosol from the different regions of the aerosol generating material on the substrate in response to one or both of the amount of air drawn by the user through the air channel and a duration of a draw of air through the air channel.

19. The reusable part according to claim 16, wherein the reusable part includes a movement mechanism configured to engage with the substrate when the replaceable part is mounted on the reusable part and the control circuit is configured to control the movement mechanism to move the substrate with respect to the at least one aerosol generating element to generate the aerosol selectively from the different regions of the aerosol generating material.

20. The reusable part according to claim 19, wherein the control circuit is configured to determine an amount of aerosol generated by each region of the aerosol generating material and to move the substrate when the region has become exhausted to generate the aerosol from a different region.

21. The reusable part according to claim 16, wherein the at least one aerosol generating element comprises a plurality of aerosol generating elements each of which is spatially positioned with respect to the substrate so that when activated each of the plurality of aerosol generating elements can generate the aerosol from the different regions of the aerosol generating material, and the control circuit is configured to activate one or more of the plurality of aerosol generating elements separately in response to the user drawing air through the air channel to generate the aerosol selectively from the different regions of the aerosol generating material in response to one or both of the amount of air drawn by the user through the air channel and a duration of a draw of air through the air channel.

22. The reusable part according to claim 21, wherein the control circuit is configured to control the plurality of aerosol generating elements to activate more than one of the aerosol generating elements if the amount of air drawn by the user through the air channel exceeds a predetermined threshold amount.

23. The reusable part according to claim 22, wherein the control circuit is configured to control the plurality of aerosol generating elements to activate a first of the plurality of the aerosol generating elements in response to the detector detecting air being drawn though the air channel and if the air is drawn through the air channel by the user for a time duration which exceeds a predetermined threshold time then the control circuit is configured to activate a second of the aerosol generating elements.

24. The reusable part according to claim 23, wherein the control circuit is configured to determine an amount of aerosol generated by each region of the aerosol generating material and to activate the second of the aerosol generating elements when the duration of the air drawn by the user through the air channel is greater than or equal to the threshold time, the threshold time being determined from an activation time of one of the first of the aerosol generating elements to exhaust a region of aerosol generating material.

25. The reusable part according to claim 23, wherein each of the plurality of aerosol generating elements comprises a cell which includes a controllable heating element connected to the control circuit.

26. The reusable part according to claim 25, wherein each of the plurality of aerosol generating elements comprises a cell which includes a controllable heating element connected to the control circuitry, the aerosol generating material being responsive to heat to generate the aerosol, and the system includes at least one temperature sensor disposed with respect to the plurality of heating elements to estimate a temperature of the heater and/or the aerosol generating material, and the control circuit is configured to control the plurality of aerosol generating elements to activate a first of the plurality of heaters in response to the detector detecting air being drawn though the air channel and to activate a second of the plurality of heaters in response to the estimated temperature.

27. The reusable part according to claim 26, wherein the control circuit is configured to control the plurality of aerosol generating elements to activate the second of the plurality of heaters in response to the estimated temperature if a rate of change of temperature with respect to time exceeds a predetermined rate of change.

28. The reusable part according to claim 27, wherein the control circuit is configured to control the plurality of aerosol generating elements to activate the second of the plurality of heaters in response to the estimated temperature if the estimated temperature exceeds a set threshold temperature.

29. The reusable part according to claim 26, wherein the at least one temperature sensor comprises a plurality of temperature sensors, each of the plurality of temperature sensors being disposed to estimate a temperature of one of the plurality of heaters.

30. A replaceable part for an aerosol provision system for generating aerosol for user inhalation, the replaceable part comprising a substrate, the substrate comprising a plurality of portions of aerosol generating material for generating the aerosol for user inhalation, wherein the replaceable part is configured to engage with an interface of a reusable part providing a plurality of aerosol generating elements each of which is disposed via the interface adjacent one of the plurality of aerosol generating portions when the replaceable part is engaged via the interface with the reusable part, wherein, in use, the plurality of aerosol generating elements are configured with respect to the substrate of the replaceable part to generate aerosol selectively from different regions of the aerosol generating material in accordance with the amount of air drawn by the user to generate a selectable amount of the aerosol.

31. The replaceable part according to claim 30, wherein the replaceable part further comprises a housing, wherein the housing is configured with an air channel and the substrate is disposed with respect to the air channel so that air drawn by the user through the air channel of the replaceable part when engaged with the reusable part causes the aerosol to be drawn through the air channel of the replaceable part for user inhalation.

32. An aerosol provision system for generating aerosol for user inhalation, the aerosol provision system comprising:
a replaceable part comprising a substrate providing an aerosol generating material for generating the aerosol for user inhalation; and
a reusable part comprising
a housing including an interface configured to operatively engage with the replaceable part, and an air channel configured at least partially in the housing to provide a passage of air drawn by the user to receive the aerosol generated from the aerosol generating material,
a detector for detecting the passage of air drawn through the air channel;
an aerosol generating element disposed with respect to the interface and configured, in use, to generate aerosol from the aerosol generating material, and
a control circuit configured to receive a signal from the detector indicating an amount of air drawn by the user and to control the aerosol generating element in response to the detector detecting the amount of air through the air channel to generate the aerosol in proportion to the amount of air drawn by the user through the air channel.

33. The aerosol provision system according to claim 32, wherein the aerosol generating material is an amorphous solid.

34. The aerosol provision system according to claim 32, wherein the aerosol generating material is a gel.

35. The aerosol provision system according to claim 32, wherein the aerosol generating element is a heater and the control circuit is configured to control an amount of heat generated by the heater in proportion to an amount of air drawn by the user through the air channel to generate the aerosol from the aerosol generating material in accordance with an amount of air drawn by the user through the air channel.

36. The aerosol provision system according to claim 32, wherein the aerosol generating element comprises a plurality of heating elements configured with respect to the substrate of the replaceable part to generate aerosol selectively from different regions of the aerosol generating material in accordance with the amount of air drawn by the user to generate a selectable amount of the aerosol.
